(19) United States
(12) Patent Application Publication
(10) Pub. No.: US 2019/0134803 A1
(43) Pub. Date: May 9, 2019

(54) Tools Made of Composite Material Structures Instead of Steel and Methods Thereof

(71) Applicant: OZAT 2000 (1999) Ltd., Sderot (IL)

(72) Inventors: Shmuel Bar-Ziv, Kfar Sava (IL); Eliezer Gerlic, Mitar (IL)

(73) Assignee: OZAT 2000 (1999) Ltd., Sderot (IL)

(21) Appl. No.: 15/751,666

(22) PCT Filed: Aug. 10, 2015
(86) PCT No.: PCT/IL2015/050812

§ 371 Date: Feb. 9, 2018

(51) Int. Cl. B25G 1/01

(52) U.S. Cl. CPC B25G 1/01

(57) ABSTRACT

A tool, comprising: a handle portion at least partially made of carbon fibers composite laminates, having a proximal end and a distal end interconnected by a main longitudinal axis X:X; said handle is characterized by at least one inner core; and, at least one outer envelope at least partially enclosing said inner core; at least one head portion in mechanical communication with said handle portion; wherein at least one of the following is being held true: said inner core is characterized by at least one unidirectional carbon fiber oriented parallel to said main longitudinal axis X:X; said outer envelope is characterized by at least one carbon fiber composite laminate oriented at an angle A relatively to said main longitudinal axis X:X; said inner core is characterized by at least one carbon fiber oriented at an angle B relatively to said main longitudinal axis X:X; any combination thereof.

### FIELD OF INVENTION

The present invention relates generally to tools, and particularly to wrenches and podgers, including a handle portion comprising carbon fibers and resins, and an insert portion for engaging a bolt, nut, or similar structure. The insert will be formed of an essentially hardened material, and in many examples will be formed of metal, or a metal-containing material.

### BACKGROUND OF THE INVENTION

Various configurations have been proposed for manufacturing wrenches and podgers with handles or other components formed of a composite material.

Patent FR2798087A discloses a composite tool handle which consists of a primary tool body, e.g. a spanner, which is made of steel alloy and has an external periphery, which is designed to fit into and be covered by the secondary body, which is made of carbon or glass fiber material. The handle may have a core body with a separate surface covering.

U.S. Pat. No. 5,062,328 discloses a plastic wrench consisting of a handle and a gripping head, having a polygonal opening in which there is embedded an open metal insert, likewise polygonal, and the walls of which form grip ping jaws, wherein the walls of the insert forming the jaw are parallel and protrude slightly from the lateral faces of the openings of each gripping head, wherein the metal insert is made from a hard, flexible and resilient metal having a coefficient of hardness of between and 50 HRC, and wherein, in the region of the jaws, the thickness E2 of the insert is between 0.5 and 0.7 times the thickness E1 of the gripping head.

U.S. Pat. No. 5,657,674 discloses a composite hammer is provided having enhanced vibration dampening characteristics. In one aspect of the invention, the composite hammer includes a handle having an elongated body and a cradle attached to a terminal end of the body. An elastomeric member substantially encapsulates the cradle and at least partially encapsulates a head structure to thereby secure the head structure to said handle. In another aspect of the invention, the hammer includes a substantially rigid elongated body having a chamber therein. An elastomeric material filler is positioned within the chamber of the hammer body to thereby enhance the vibration dampening characteristics of said hammer.

Patent application US 2003/0154829 A1 discloses a hand tool with a composite handle includes a first body made of a steel alloy having a skeletal extension protruding from one end, and a second body coated on the outer periphery of the skeletal extension. The second body is made of composite material such as carbon fiber, fiberglass or the like. The composite material lighter than the steel alloy so that the hand tool is convenient to use. The composite material is a good insulator that can effectively prevent the user from getting an electric shock.

Lastly, patent application US 20150101459 A1 discloses wrenches having a portion thereof including carbon fibers. Example wrenches may have a handle portion comprising the carbon fibers; which in some cases can be formed as a part of a composite laminate structure of at least a portion of the handle. Example wrenches will often include an insert portion for engaging a bolt, nut, or similar structure. In most cases, the insert will be formed of a relatively hardened material, such as a metal, or a metal-containing, material.

The main downside of all the above mentioned disclosures is that such devices do not provide tools with lower weights without compromising the strength of the tool and the resistance to high pressures and forces required to be applied on such tools. Therefore, there is a long felt need for a tool, like a wrench or a podger, which is light, strong and capable to resist the great pressures and forces required to be applied to those tools.

### SUMMARY OF THE INVENTION

It is hence one object of the invention to disclose a tool, comprising: a handle portion at least partially made of carbon fibers composite laminates, having a proximal end and a distal end interconnected by a main longitudinal axis X:X; said handle is characterized by at least one inner core; and, at least one outer envelope at least partially enclosing said inner core; at least one head portion in mechanical communication with said handle portion; wherein at least one of the following is being held true: said inner core is characterized by at least one unidirectional carbon fiber oriented parallel to said main longitudinal axis X:X; said outer envelope is characterized by at least one carbon fiber composite laminate oriented at an angle A relatively to said main longitudinal axis X:X; said inner core is characterized by at least one carbon fiber oriented at an angle B relatively to said main longitudinal axis X:X; any combination thereof.

Another object of the present invention is to disclose the tool wherein said head portion is made of at least one element selected from a group consisting of metal, glass, plastic, graphene, diamond, composite materials and any combination thereof.

Another object of the present invention is to disclose the tool wherein said tool additionally comprising at least one actuation portion.

Another object of the present invention is to disclose the tool wherein said actuation portion allocated within at least one end selected from a group consisting of said proximal end, said distal end and any combination thereof.

Another object of the present invention is to disclose the tool wherein said actuation portion is made of at least one element selected from a group consisting of metal, glass, plastic, graphene, diamond, composite materials and any combination thereof.

Another object of the present invention is to disclose the tool wherein A is in the range of about degrees to about 60 degrees.

Another object of the present invention is to disclose the tool wherein B is in the range of about 0 degrees to about 180 degrees.

Another object of the present invention is to disclose the tool wherein A is about 45 degrees.

Another object of the present invention is to disclose the tool wherein B is about 0 degrees.

Another object of the present invention is to disclose the tool wherein said carbon fiber composite laminate at least partially encapsulate said head portion.

Another object of the present invention is to disclose the tool wherein said head portion at least partially encapsulate said carbon fiber composite laminate.

Another object of the present invention is to disclose the tool wherein said carbon fiber composite laminate at least partially encapsulate said actuation portion;

Another object of the present invention is to disclose the tool wherein said actuation portion at least partially encapsulate said carbon fiber composite laminate.

Another object of the present invention is to disclose the tool wherein said head portion is adapted to engage a bolt object.

Another object of the present invention is to disclose the tool wherein said actuation portion is adapted to engage a bolt object.

Another object of the present invention is to disclose the tool wherein said actuation portion is adapted to be stroked by a hand tool or a powered tool.

Another object of the present invention is to disclose the tool wherein the power of said powered tool is selected from a group consisting of: electricity, magnetic field, wind, solar, hydro, chemical, heat, nuclear, batteries, steam, pneumatic, pressure and any combination thereof.

Another object of the present invention is to disclose the tool wherein said handle portion is essentially straight.

Another object of the present invention is to disclose the tool wherein said handle portion is essentially not straight.

Another object of the present invention is to disclose the tool wherein said tool further comprise a vibration dampening member.

It is hence one object of the invention to disclose a method for manufacturing a tool comprising the steps of: forming a handle portion at least partially made of carbon fibers composite laminates, having a proximal end and a distal end interconnected by a main longitudinal axis X:X; said handle is characterized by at least one inner core; and, at least one outer envelope at least partially enclosing said inner core; forming at least one head portion in mechanical communication with said handle portion; wherein at least one of the following is being held true: said inner core is characterized by at least one unidirectional carbon fiber oriented parallel to said main longitudinal axis X:X; said outer envelope is characterized by at least one carbon fiber composite laminate oriented at an angle A relatively to said main longitudinal axis X:X; said inner core is characterized by at least one carbon fiber oriented at an angle B relatively to said main longitudinal axis X:X; any combination thereof.

Another object of the present invention is to disclose the method wherein said head portion is made of at least one element selected from a group consisting of metal, glass, plastic, graphene, diamond, composite materials and any combination thereof.

Another object of the present invention is to disclose the method wherein said tool additionally comprising at least one actuation portion.

Another object of the present invention is to disclose the method wherein said actuation portion allocated within at least one end selected from a group consisting of said proximal end, said distal end and any combination thereof.

Another object of the present invention is to disclose the method wherein said actuation portion is made of at least one element selected from a group consisting of metal, glass, plastic, graphene, diamond, composite materials and any combination thereof.

Another object of the present invention is to disclose the method wherein A is in the range of about degrees to about 60 degrees.

Another object of the present invention is to disclose the method wherein B is in the range of about 0 degrees to about 180 degrees.

Another object of the present invention is to disclose the method wherein A is about 4 degrees.

Another object of the present invention is to disclose the method wherein B is about 0 degrees.

Another object of the present invention is to disclose the method wherein said carbon fiber composite laminate at least partially encapsulate said head portion.

Another object of the present invention is to disclose the method wherein said head portion at least partially encapsulate said carbon fiber composite laminate.

Another object of the present invention is to disclose the method wherein said carbon fiber composite laminate at least partially encapsulate said actuation portion;

Another object of the present invention is to disclose the method wherein said actuation portion at least partially encapsulate said carbon fiber composite laminate.

Another object of the present invention is to disclose the method wherein said head portion is adapted to engage a bolt object.

Another object of the present invention is to disclose the method wherein said actuation portion is adapted to engage a bolt object.

Another object of the present invention is to disclose the method wherein said actuation portion is adapted to be stroked by a hand tool or a powered tool.

Another object of the present invention is to disclose the method wherein the power of said powered tool is selected from a group consisting of: electricity, magnetic field, wind, solar, hydro, chemical, heat, nuclear, batteries, steam, pneumatic, pressure and any combination thereof.

Another object of the present invention is to disclose the method wherein said handle portion is essentially straight.

Another object of the present invention is to disclose the method wherein said handle portion is essentially not straight.

Another object of the present invention is to disclose the method wherein said tool further comprise a vibration dampening member.

### BRIEF DESCRIPTION OF THE FIGURES

FIG. 1 is an exploded schematic image of one embodiment of the present invention.

FIG. 2 is a schematic image of one embodiment of the present invention.

FIG. 3 is a schematic multi zoom-in image of one embodiment of the present invention.

FIG. 4 is a schematic image of another embodiment of the present invention.

FIG. 5 is a schematic diagram of varieties of carbon fibers.

FIGS. 6A and 6B show the fatigue resistance of Carbon Fiber and other structural materials.

FIGS. 7A and 7B show twill and plain weave patterns respectively.

### DETAIL DESCRIPTION OF THE PREFERRED EMBODIMENTS

The following description is provided, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a tool that is also light and also adapted to endure the great stresses required.

The term “about” refers hereinafter as ±25% of the specified value.

The term “bolt object” refers hereinafter to any of a bolt head (of any shape, such a 4-sided, 6-sided, etc.), a nut for a bolt (which may again have any suitable number of sides or “flats”), or any bolt head like-mechanism, having a plurality of sides which are intended to be engaged to facilitate rotation, or restriction from rotation, of the mechanism.

The term “Young's Modulus” (also known as the tensile modulus or elastic modulus) refers hereinafter to the mechanical property of linear elastic solid materials. It measures the force (per unit area) that is needed to stretch (or compress) a material sample. Therefore, the Young's modulus is a measure of the stiffness of a solid material.

The term “stiffness” refers hereinafter to the rigidity of an object—the extent to which it resists deformation in response to an applied force. The complementary concept is flexibility or pliability: the more flexible an object is, the less stiff it is.

The term “strength” refers hereinafter to the amount of force it can withstand and still recover its original shape.

The term “hardness of a material” refers hereinafter to the relative resistance that its surface imposes against the penetration of a harder body.

The term “toughness” refers hereinafter to the amount of energy that a material can absorb before fracturing.

### High Tensile Steel

One example of a high tensile steel used in the manufacturing of tools is the “4140 HIGH TENSILE STEEL” (refer hereinafter as 4140). 4140 is a 1% chromium—molybdenum medium hardenability general purpose high tensile steel—generally supplied hardened and tempered in the tensile range of 850-1000 Mpa (condition T). 4140 is now available with improved machinability, which greatly increases feeds and/or speeds, while also extending tool life without adversely affecting mechanical properties. Pre-hardened and tempered 4140 can be further surface hardened by flame or induction hardening and by nitriding. 4140 is used extensively in most industry sectors for a wide range of applications such as: Adapters, Arbors, Axle Shafts, Bolts, Crankshafts, Connection Rods, Chuck Bodies, Collets, Conveyor Pins and Rolls, Ejector Pins, Forks, Gears, Guide Rods, Hydraulic Shafts and Parts, Lathe Spindles, Logging Parts, Milling Spindles, Motor Shafts, Nuts, Pinch Bars, Pins Various, Pinions, Pump Shafts, Rams, Sockets, Spindles, Sprockets, Studs, Tool Holders, Torsion Bars, Worms, etc.

Mechanical Property Requirements for Steels in the Heat-Treated
Condition for Turned, Peeled or Ground Finish to AS1444-1996 4140
and BS970 Part 3-1991 709M40

| Mechanical Property Designation | | T |
|---|---|---|
| Limited Ruling Section mm | | 100 |
| Tensile Strength Mpa | Min | 850 |
| | Max | 1000 |
| 0.2% Proof Stress Mpa | Min | 665 |
| Elongation on 5.65√S0% | Min | 13 |
| Izod Impact J | Min | 54 |
| Charpy Impact J | Min | 50 |
| Hardness Brinell HB | Min | 248 |
| | Max | 302 |

*Material stocked generally in condition T

Mechanical Property Requirements for Steels Heat-Treated, and
then Cold Finished to AS 1444-1996, and BS 970 Part 3-1991 709 M40

| Mechanical Property Designation | | T |
|---|---|---|
| Limited Ruling Section mm | | 63 |
| Tensile Strength Mpa | Min | 850 |
| | Max | 1000 |
| 0.2% Proof Stress Mpa | Min | 755 |
| Elongation on 5.65√S0% | Min | 9 |
| Hardness Brinell HB | Min | 248 |
| | Max | 302 |

*Material stocked generally in condition T

### Carbon Fibers

A Carbon Fiber is a fibrous carbon material having a micro graphite crystal structure made by fibrillation of Acrylic resin, a well-known textile material, or from oil/coal pitch and then by being given a certain heat treatment (http://www.carbonfiber.gr.jp/english/material/what.html)—incorporated herein as reference.

Carbon fibers, under industrial production now, are classified into PAN-based, pitch-based and rayon-based. Among them, PAN-based carbon fiber is in the largest production and best used in volume. In the beginning of 1970's, commercial production of PAN-based and isotropic pitch-based carbon fibers was started on a large scale. In the latter half of 1980's, anisotropic pitch-based carbon fiber manufacturers broke into the market.

Usage of carbon fiber by itself is not the rule. Commonly, customers apply carbon fibers for reinforcement and/or functionality of composite materials, made with resin, ceramic or metal as matrix. Carbon fibers are extensively applied to a large variety of applications with supreme mechanical characteristics (specific tensile strength, specific modulus) and other characteristics due to carbon matter (low density, low coefficient of thermal expansion, heat resistance, chemical stability, self-lubricity, etc.).

Carbon Fibers, having supreme characteristics, are adopted in wide varieties of uses. Suppliers are able to provide, by using different raw material and applying divergent production processes, wide diversity of the fibers having different specifications. Please find below diversified types and respective features of the fibers.

### Two Types by Raw Material

PAN Type Carbon Fiber: A type of the fiber, produced by carbonization of PAN precursor (PAN: Polyacrylonitrile), having high tensile strength and high elastic modulus, extensively applied for structural material composites in aerospace and industrial field and sporting/recreational goods.

Pitch Type Carbon Fiber: Another type of the fiber, produced by carbonization of oil/coal pitch precursor, having extensive properties from low elastic modulus to ultra-high elastic modulus. Fibers with ultra-high elastic modulus are extensively adopted in high stiffness components and various uses as utilizing high thermal conductivity and/or electric conductivity.

### Types by Mechanical Properties

### Ultra High Elastic Modulus Type (UHM)

Tensile elastic modulus: 600 GPa or higher/Tensile strength: 2,500 MPa or higher

### High Elastic Modulus Type (HM)

Tensile elastic modulus: 350-600 GPa/Tensile strength: 2,500 MPa or higher

### Intermediate Elastic Modulus Type (IM)

Tensile elastic modulus: 280-350 GPa/Tensile strength: 3,500 MPa or higher

### Standard Elastic Modulus Type (HT)

Tensile elastic modulus: 200-280 GPa/Tensile strength: approximately 2,500 MPa or higher

### Low Elastic Modulus Type (LM)

Tensile elastic modulus: 200 GPa or lower/Tensile strength: 3,500 MPa or lower

### Carbon Fiber Types by the Secondary Processing

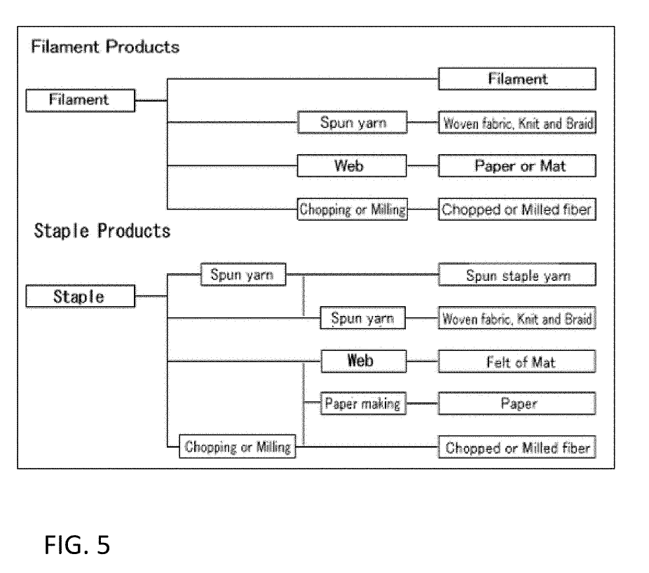

There are two types of Carbon Fibers: Filament and Staple. In the subsequent processing, the fibers are given varieties, shown in FIG. 5, of the final product forms.

### Carbon Fiber's Special Features and its Characterizing Performances

The fibers have low specific gravity, exquisite mechanical properties (high specific tensile strength, high specific elastic modulus, etc.) and attractive performances (electric conductivity, heat resistance, low thermal expansion coefficient, chemical stability, self-lubrication property, high heat conductivity, etc.).

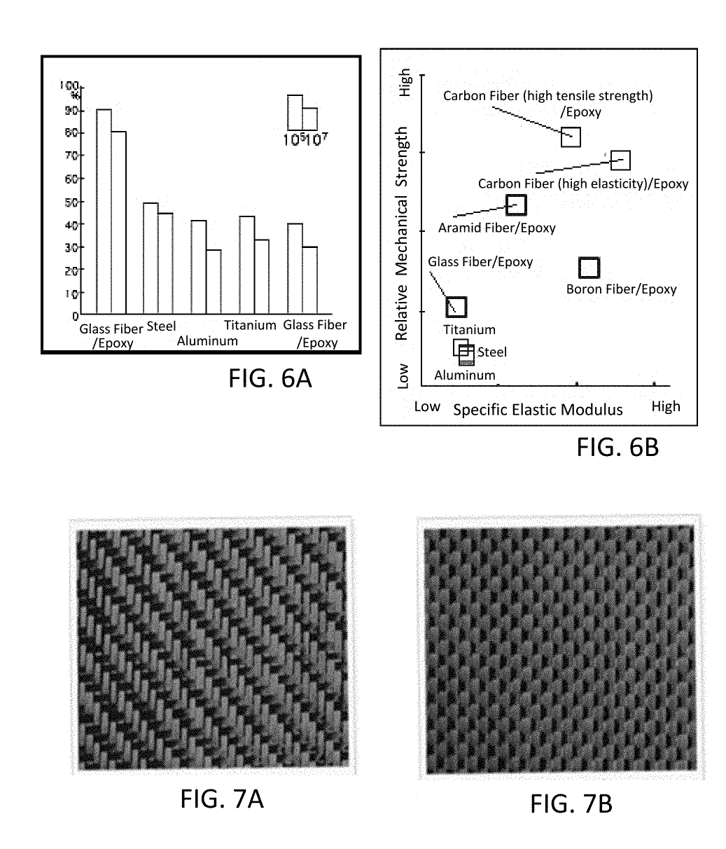

Carbon Fiber Reinforced Plastics (CFRP) is superior to steel or glass fiber reinforced plastics (GFRP) in its specific tensile strength and specific elastic modulus (specific rigidity). That is to say, CFRP is “Light in Weight and Strong” in its mechanical performances. Moreover, fatigue resistance of Carbon Fiber surpasses that of other structural materials, as can be seen in FIGS. 6A and 6B:

Carbon Fiber customers have developed wide varieties of usage of the fibers making best use of the fibers' favorable properties as presented below.

| Types | Specifications | Major Usage |
|---|---|---|
| Filament | A yarn constituted of numerous | Resin reinforcement material for |
| | number of fiber: twisted, untwisted, | CFRP, CFRTP or C/C |
| | twisted-and-untwisted | composites, having such usage as |
| | | Aircraft/Aerospace equipment, |
| | | sporting goods and industrial |
| | | equipment parts |
| Tow | An untwisted bundle of yarn | Resin reinforcement material for |
| | constituted of extremely numerous | CFRP, CFRTP or C/C |
| | number of fiber | composites, having such usage as |
| | | Aircraft/Aerospace equipment, |
| | | sporting goods and industrial |
| | | equipment parts |
| Staple Yarn | A yarn made of spinning of staples | Heat Insulator, Anti-friction |
| | | material, C/C composite parts |
| Woven | A woven sheet made of filament or | Resin reinforcement material for |
| fabric | staple yarn | CFRP, CFRTP or C/C |
| | | composites, having such usage as |
| | | Aircraft/Aerospace equipment, |
| | | sporting goods and industrial |
| | | equipment parts |
| Braid | A braided yarn made of filament or | Resin reinforcement material |
| | tow | particularly suitable for |
| | | reinforcement of tubular |
| | | products |
| Chopped | A chopped fiber made of sized or | Compounded into plastics/resins |
| fiber | non-sized fiber | or Portland cement to improve |
| | | mechanical performances, |
| | | abrasion characteristic, electric |
| | | conductivity and heat resistance |
| Milled | Powder made by milling fiber in a | Compounded into plastics/resins |
| | ball-mill etc. | or rubber to improve mechanical |
| | | performances, abrasion |
| | | characteristic, electric |
| | | conductivity and heat resistance |
| Felt/Mat | A felt or mat made by layering up of | Heat insulator, base material for |
| | staple by carding etc. then needle- | molded heat insulator, protective |
| | punched or strengthened by organic | layer for heat resistance and base |
| | binders | material for corrosion-resisting |
| | | filter |
| Paper | A paper made from staple by dry or | Anti-electrostatics sheets, |
| | wet paper-making | electrodes, speaker-cone and |
| | | heating plate |
| Prepreg | An intermediate material in a form | Aircraft/Aerospace equipment, |
| | of half-hardened sheets made of | sporting goods and industrial |
| | Carbon Fibers impregnated with | equipment parts needing |
| | thermo-setting resin, qualities of | lightness in weight and high |
| | which being stable and sustained | performances |
| | long enough and therefore easily | |
| | applicable for automatic sheet- | |
| | layering | |
| Compounds | A material for injection molding etc. | Housing etc. of OA equipment |
| | made of mixture of thermo-plastics | taking advantages of electric |
| | or thermo-setting resins added by | conductivity, rigidity and |
| | various additives and chopped fiber | lightness in weight |
| | and then being compounded | |

Carbon fiber reinforcement is available as a woven fabric, rovings or unidirectional fabric (http://www.easycomposites.co.uk/Learning/Carbon-Fibre-Cloth-Explained.aspx, incorporated herein as reference).

### Woven Fabrics

Woven fabric is the most common and versatile way to work with carbon fiber. Typically bunches of carbon fiber strands (yarn) are woven bi-directionally (the weft and the warp). The manner in which the weft and the warp are interwoven is the weave pattern.

### 2/2 Twill

The most commonly used weave pattern for carbon fibre is ‘2/2 Twill’, as shown in FIG. 7A. In this pattern the weft goes over two intersecting warps and then under two (hence 2/2) to create a woven fabric with a predominantly diagonal pattern to it. This weave pattern is looser than Plain Weave allowing the fabric to drape more easily which is especially useful when laminating into mould surfaces with compound curves and contours. The looser pattern of the weave means that it must be handled more carefully that plain weave and also that accidental distortion to the weave (relevant where cosmetic appearance is important) is more likely.

### Plain Weave

Plain weave fabric is the second most widely used of the woven carbon fabrics, as shown in FIG. 7B. In this weave the weft goes over one warp and under the next, creating a grid-like pattern. Plain weave is a slightly tighter weave pattern that 2/2 twill and therefore easier to handle without distorting, however it is not as drape-able as 2/2 twill and therefore it is not the first choice for compound contours.

### Braids/Sleeves

Braids are continuous tubes (or sleeves) of woven carbon fabric. Elongating the braid (stretching it out) will reduce its diameter, allowing braids to be adjusted to be a perfect fit around mandrels or into tubes of varying diameter.

### Tapes

Tapes are simply thin strips (usually supplied on a roll) of woven carbon fabric, most commonly plain weave. Tapes of woven carbon fiber are useful for providing localized reinforcement without the need to cut down large pieces of fabric.

### Other Weaves

Satin weave, harness weave, fish weave etc. are all different weave patterns for carbon fabric although they are used much less widely than 2/2 Twill and Plain Weave. In advanced composites there are almost no situations where these weave patterns are used or are advantageous and so unless you have a very unusual requirement you are unlikely to need or encounter these more obscure weaves.

### Rovings

Rovings is the name given to the “bunches” of carbon fibers that are usually woven into fabrics. Unwoven rovings are sometimes used as localized reinforcement where they are often wound around a repair.

### Unidirectional Carbon Fiber

Unidirectional carbon fiber is a reinforcement where all (or almost all) of the carbon fibers are aligned in the same direction. The only thing holding the fibers together will be occasional strands of either carbon or polyester running across the fibers at 90 degrees. Unidirectional material is used in applications where all of the forces on a part will be in one direction (such as the body of an archery bow). Alternate layers of unidirectional fibers can be positioned with different orientation to allow any combination of bias for the strength of the part to be achieved.

In one embodiment of the present invention, any kind of the aforementioned carbon fibers can be used.

The main principle of the present invention is to provide a tool that is very strong and is very light, in comparison to similar made-of-steel tools.

In one embodiment, the technological design of the tool provides the later with the strength necessary to endure the high forces applied to the same.

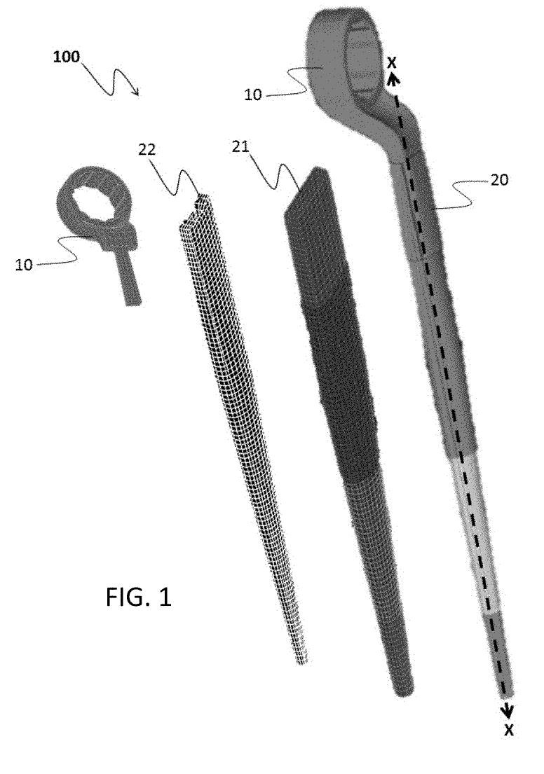

Referring now to FIG. 1, showing a schematic example of one possible embodiment of the present invention. The tool 100 is formed mainly by two parts: the head portion 10, which is made, in this example, of steel and comprises the bolt object actuator, and the handle portion 20, which is made of carbon fibers composite laminates. A main longitudinal axes X:X is shown. The handle portion is made by a main core of unidirectional carbon fibers 22 aligned in the direction of the main longitudinal axes X:X, and an outer enveloped 21 made of carbon fiber fabrics. The fabrics are oriented at about 45 degrees of the direction of the unidirectional carbon fiber core. The head portion 10 is mechanically interconnected to the carbon fiber core 22. The core is manufactured around the head portion 10.

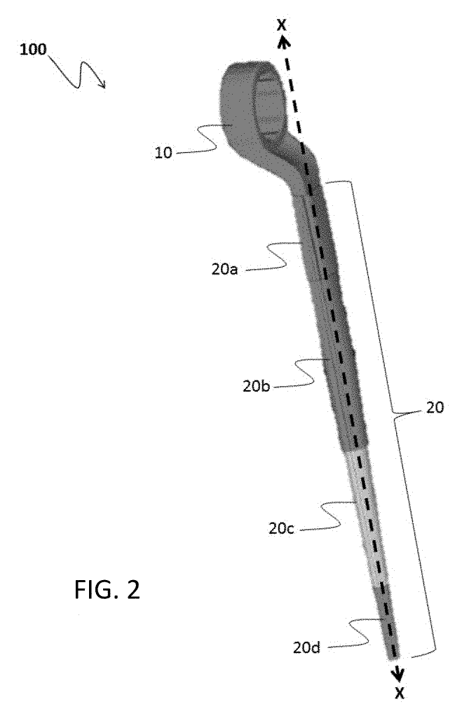

Referring now to FIG. 2, showing a schematic example of one possible embodiment of the present invention. The tool 100 is formed mainly by two parts: the head portion 10, which is made of steel and comprises the bolt object actuator, and the handle portion 20, which is made of carbon fibers composite laminates. It can be also seen that the handle portion 20 is schematically divided into four (4) different areas 20a-d. Each area is different to the others and each one possesses different physical-mechanic characteristics.

The combination of the different areas in the predetermined order confers the strength necessary to the tool. Furthermore, it is this specific design of these areas that enable the manufacture of such long and strong tool.

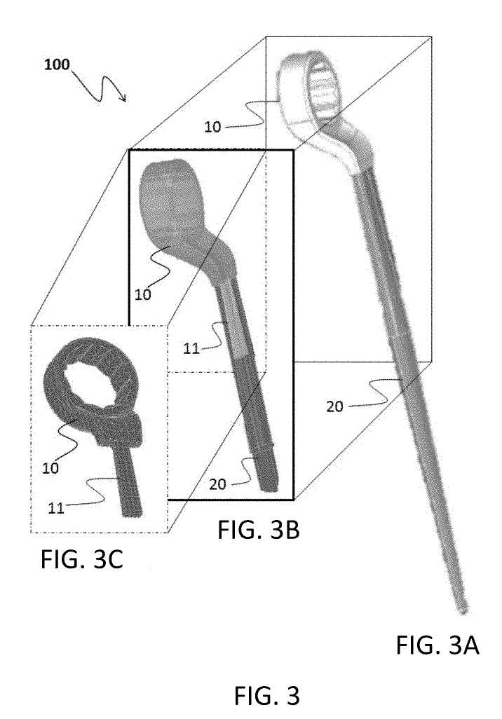

Referring now to FIG. 3, showing a schematic example of one possible embodiment of the present invention. The tool 100, as previously presented in FIGS. 1-2, is formed mainly by two parts: the head portion 10 comprising the bolt object actuator, which is made of steel, and the handle portion 20, which is made of carbon fibers composite laminates—FIG. 3a. It can be also seen two different zoom-ins of the tool—FIG. 3b and FIG. 3c. In FIG. 3b can be seen how the head portion 10 is mechanically interconnected to the handle portion 20 by means of the extension 11. The extension 11 comprises a proximal end (close to the head portion 10) and a distal end (deep into handle portion 20). The proximal end is relatively narrower than the distal end. This configuration ensures that the head portion 10 doesn't detach from the handle portion 20. The configuration of the extension 11 of the head portion 10 can be clearly seen in FIG. 3c.

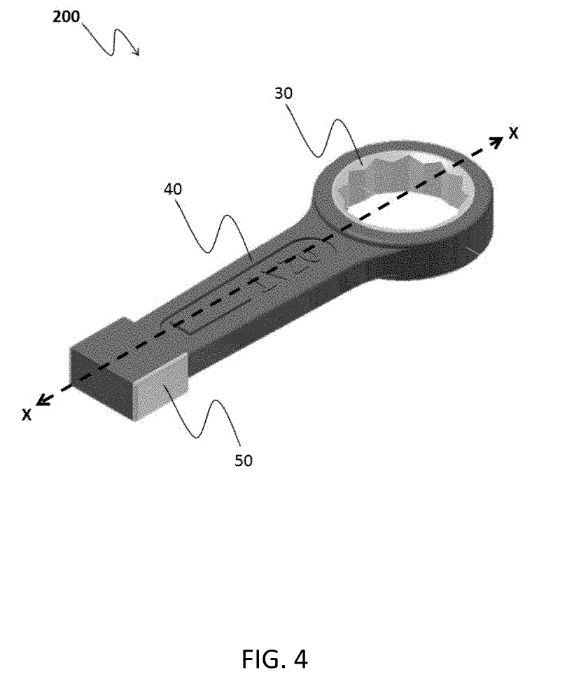

Referring now to FIG. 4, showing a schematic example of another embodiment of the present invention. The tool 200 comprises a head portion 30 comprising a bolt object actuator, a body or handle portion 40 and an actuation portion (in this case a striking zone) 50. The head portion 30 and actuation portion 50 are made of steel, while the body or handle portion 40 is made of carbon fibers composite laminates, using the same principals of core/envelope as presented in FIGS. 1-3.

In one embodiment, the body/handle portion is made by a core of unidirectional carbon fibers in order to confer the necessary linear strength necessary for a tool.

In one embodiment, the core is at least partially enclosed by an outer enveloped made of carbon fibers fabrics, laid in a direction different of those of the unidirectional carbon fibers, in order to confer the necessary lateral strength for a tool.

In one embodiment, the head portion is made of at least one element selected from a group consisting of metal, glass, plastic, graphene, diamond, composite materials and any combination thereof.

In one embodiment, the tool may comprise an additional actuation portion that may be located at any portion of the body/handle portion. The actuation portion is made of at least one element selected from a group consisting of metal, glass, plastic, graphene, diamond, composite materials and any combination thereof.

The actuation portion can be useful to allow interaction with other tools, without damaging the tool in question.

In one embodiment, said other tools can be hand used or powered used. Said tools may comprise, but not limited to: hammers, impact tools.

In another embodiment, said powered tool is selected from a group consisting of: electricity, magnetic field, wind, solar, hydro, chemical, heat, nuclear, batteries, steam, pneumatic, pressure and any combination thereof.

In one embodiment, the tool may further comprise a vibration dampening member.

It is clear that by these examples that any tool can be manufactured using these principals.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A tool, comprising:
a. a handle portion at least partially made of carbon fibers composite laminates, having a proximal end and a distal end interconnected by a main longitudinal axis X:X;
said handle is characterized by at least one inner core; and, at least one outer envelope at least partially enclosing said inner core;
b. at least one head portion in mechanical communication with said handle portion;
wherein at least one of the following is being held true:
(a) said inner core is characterized by at least one unidirectional carbon fiber oriented parallel to said main longitudinal axis X:X;
(b) said outer envelope is characterized by at least one carbon fiber composite laminate oriented at an angle A relatively to said main longitudinal axis X:X;
(c) said inner core is characterized by at least one carbon fiber oriented at an angle B relatively to said main longitudinal axis X:X;
(d) any combination thereof;
further wherein said outer envelope of said handle portion comprises at least two different areas in a predetermined order characterized by different angle A relative to said main longitudinal axis X:X such that each of said areas possessing different physical-mechanic characteristics selected from the group consisting of tensile strength, elastic modulus and any combination thereof.

2. The tool of claim 1, wherein said head portion is made of at least one element selected from a group consisting of metal, glass, plastic, graphene, diamond, composite materials and any combination thereof.

3. The tool of claim 1, wherein said tool additionally comprising at least one actuation portion.

4. The tool of claim 1, wherein said actuation portion allocated within at least one end selected from a group consisting of said proximal end, said distal end and any combination thereof.

5. The tool of claim 1, wherein said actuation portion is made of at least one element selected from a group consisting of metal, glass, plastic, graphene, diamond, composite materials and any combination thereof.

6. The tool of claim 1, wherein A is in the range of about 30 degrees to about 60 degrees.

7. The tool of claim 1, wherein B is in the range of about 0 degrees to about 180 degrees.

8. The tool of claim 1, wherein A is about 45 degrees.

9. The tool of claim 1, wherein B is about 0 degrees.

10. The tool of claim 1, wherein said carbon fiber composite laminate at least partially encapsulate said head portion;

11. The tool of claim 1, wherein said head portion at least partially encapsulate said carbon fiber composite laminate.

12. The tool of claim 1, wherein said carbon fiber composite laminate at least partially encapsulate said actuation portion;

13. The tool of claim 1, wherein said actuation portion at least partially encapsulate said carbon fiber composite laminate.

14. The tool of claim 1, wherein said head portion is adapted to engage a bolt object.

15. The tool of claim 1, wherein said actuation portion is adapted to engage a bolt object.

16. The tool of claim 1, wherein said actuation portion is adapted to be stroked by a hand hammer or a powered tool.

17. The tool of claim 16, wherein the power of said powered tool is selected from a group consisting of: electricity, magnetic field, wind, solar, hydro, chemical, heat, nuclear, batteries, steam, pneumatic, pressure and any combination thereof.

18. The tool of claim 1, wherein said handle portion is essentially straight.

19. (canceled)

20. The tool of claim 1, wherein said tool further comprise a vibration dampening member.

21. A method for manufacturing a construction tool comprising the steps of:
a. forming a handle portion at least partially made of carbon fibers composite laminates, having a proximal end and a distal end interconnected by a main longitudinal axis X:X;
said handle is characterized by at least one inner core; and, at least one outer envelope at least partially enclosing said inner core;
b. forming at least one head portion in mechanical communication with said handle portion;
wherein at least one of the following is being held true:
c. said inner core is characterized by at least one unidirectional carbon fiber oriented parallel to said main longitudinal axis X:X;
d. said outer envelope is characterized by at least one carbon fiber composite laminate oriented at an angle A relatively to said main longitudinal axis X:X;
e. said inner core is characterized by at least one carbon fiber oriented at an angle B relatively to said main longitudinal axis X:X;
f. any combination thereof;
further wherein said step of forming said handle portion comprises a step of forming at least two different areas in a predetermined order in said outer envelope characterized by different angle A relative to said main longitudinal axis X:X such that each of said areas possessing different physical-mechanic characteristics selected from the group consisting of tensile strength, elastic modulus and any combination thereof.

22-40. (canceled)
